(19) United States
(12) Patent Application Publication
(10) Pub. No.: US 2006/0023928 A1
(43) Pub. Date: Feb. 2, 2006

(54) Method for automatic sorting and representation of medical data sets

(76) Inventor: Stefan Assmann, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/190,097

(22) Filed: Jul. 26, 2005

(30) Foreign Application Priority Data
Jul. 26, 2004 (DE) 10 2004 036 216.5

(51) Int. Cl. G06K 9/00

(52) U.S. Cl. 382/131

(57) ABSTRACT

In a method for automatic sorting and representation of medical data sets, each data set originates from a medical examination and has at least two features. All data sets that have a determinable identical value of a first of the features and a non-identical value of a second of the features are automatically ordered in a sequence corresponding to the second feature, and are shown on a display medium corresponding to the sequence.

### BACKGROUND OF THE INVENTION

1. Field of the Invention

The present invention concerns a method for automatic sorting and representation of medical data sets, each data set originates from a medical examination and exhibiting at least two features. 2. Description of the Prior Art

A number of data sets that subsequently must be evaluated by a physician are frequently generated in examinations, in particular in the case of imaging medical diagnostics. For example, in magnetic resonance examinations various slice sequences are acquired at various positions of the human body. Each slice sequence represents a slice at the same position relative to different points in time and thus can be composed of a number of individual magnetic resonance images. The number of the measured data sets grows by the acquisition of various slice sequences at various positions. In an examination of the influence of medicine on the human body, the number of the measured data sets increases further since for that purpose slice sequences frequently must be measured respectively with a number of dosages of the medicine. Thus, for example, in stress examinations various doses of a stress agent are administered and slice sequences are acquired at various positions of the heart of a patient. To generate a finding, the physician must sort the measured data sets in order to be able to detect the influence of the stress agent dose using the acquired images. It is possible, for example, to simultaneously show measurements of the same slice position with various stress agent doses on a display medium and thus to make a direct comparison of the effects of the stress agent dose. It is also possible to simultaneously display the influence of the stress agent dose on various regions. For this purpose, the physician must select and correspondingly sort the images from a number of the measured data sets. This procedure is thereby very time-consuming for the physician. In particular, a change of the viewpoint on the display medium requires a reselection and resorting of the data sets. This occurs, for example, in the case of a change of the display of various stress agent doses for display of various slice positions. A faster changing between the two views is not possible.

### SUMMARY OF THE INVENTION

An object of the present invention is to provide a method that makes such sorting and display of medical data sets easier.

This object is achieved by a method for sorting and display of medical data sets that each originate from a medical examination and each has at least two features, wherein all data sets that have a determinable identical value of a first of the features and a non-identical value of the second of the features are automatically ordered in a series corresponding to the second feature and displayed on a display medium corresponding to the series. The evaluating physician thus can establish an arbitrary feature of the data sets and select all data sets that have a corresponding value of the feature and sort them in a series using the second feature. The process, which conventionally had to be executed manually, is thereby automated and significantly accelerated. In particular the established feature can be changed or the value of the feature can be varied nearly without effort for the physician, such that other data sets are displayed.

In an embodiment of the method, each data set has a third feature, with which the selection of the data sets for representation can be limited. A relevant selection can easily be made from the (often large) number of the data sets using the third feature.

In a further embodiment of the method, only the data sets with a determinable identical value of the third feature are shown on the display medium. The assessing physician can thereby display the relevant data sets from among the large number of data sets.

In another embodiment, given a change of the determination of the value of the third feature, during the display of the data sets a corresponding new selection of data sets according to the first feature is selected and sorted and displayed according to the second feature. The physician can thereby view a large data set in a simple manner and a number of selections of data sets can be displayed on the display medium, sorted in succession.

### DESCRIPTION OF THE DRAWINGS

FIG. 1 is a schematic flowchart of the inventive method.

FIG. 2 is a schematic representation of data sets on a display medium in accordance with the invention.

### DESCRIPTION OF THE PREFERRED EMBODIMENTS

In a magnetic resonance stress examination, various doses of a stress agent are typically administered and magnetic resonance exposures are typically measured at various points of the heart. Slices are typically acquired at four different positions with each dose. A sequence of various images is acquired in succession at each slice position so that a time curve is documented. The corresponding image file denoting which slice belongs to which dose is stored in the header. For the physician, for generation of a finding it is now important either to show the same slice multiple times on the display medium for various doses of the stress means, or to display a number of slices for a dose on the display medium. Easy access to the slices measured in temporal succession is thereby desirable.

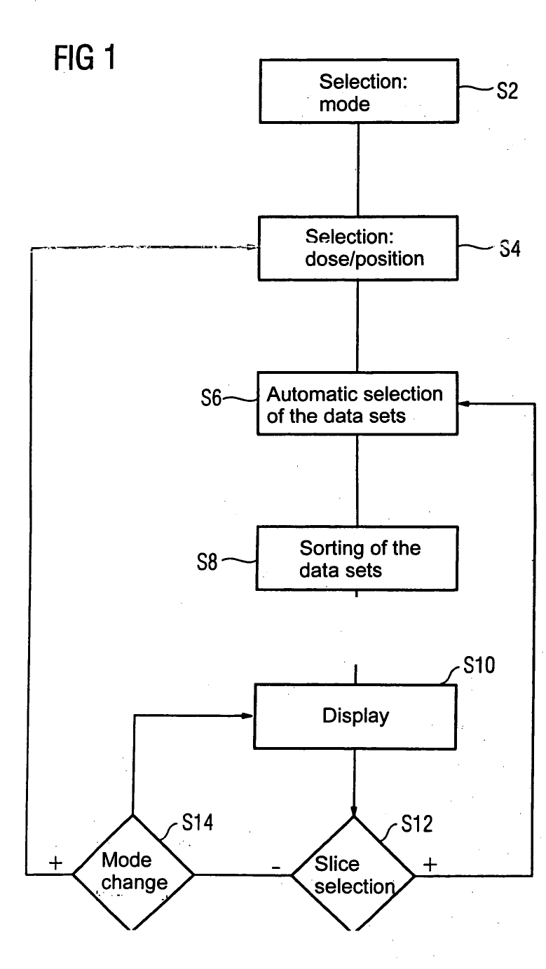

According to FIG. 1, the representation mode is selected by the physician in a first method step S2. This establishes whether various slice positions of various doses of the stress agent should be shown. In a second method step S4, the value range of the dosage, or the slice positions to be shown, are selected by the physician. An automatic selection of the data sets corresponding to the requirements thereupon ensues in a third method step S6. The data sets corresponding to the sequence are sorted in a fourth method step S8, for example with increasing stress agent dose. The data sets are displayed on a display medium in a fifth method step S10. The physician now has the possibility to navigate the respective slice within the time sequence, which is prompted in a sixth method step S12. As soon as the physician wants to see the slices of a different point in time, the corresponding data sets are in turn automatically selected in a sorted manner and are shown on the display medium in step S6. Moreover, there is the possibility to change the representation mode, which is prompted in the method step S14. If the representation mode should be changed, the method proceeds with step S; otherwise the data sets continue to be displayed.

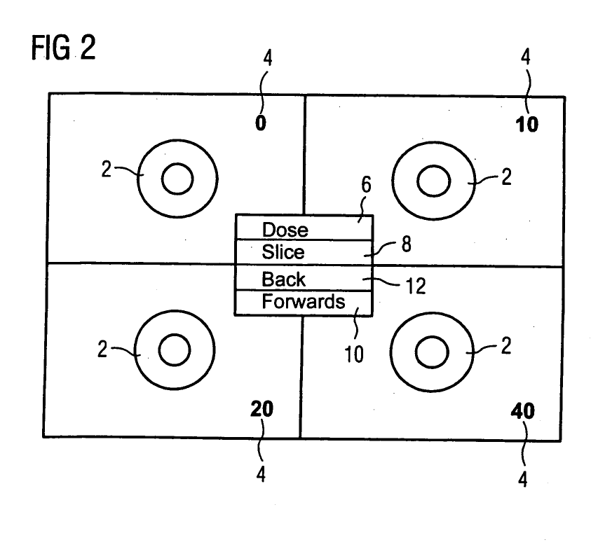

As shown in FIG. 2, four magnetic resonance images originating from corresponding data sets are schematically shown on the display medium that respectively map the anatomy 2 of a patient. They show the same slice under the influence of four different doses 4 of the stress agent, which is indicated by corresponding numbers. The physician can change the mode by means of one of the pushbuttons 6 or 8 and thus display various slice positions with regard to one dose. Moreover, there are two pushbuttons 10 and 12 by means of which the time sequence of the slice sequence can be navigated. Given activation of the pushbutton 10, the images measured temporally after the immediately shown magnetic resonance images are thus shown; the temporally preceding magnetic resonance images are shown given activation of the pushbutton 12. With each activation of a pushbutton 6, 8, 10 or 12, the specifications of corresponding data sets are selected, sorted and shown on the display medium according to the method shown in FIG. 1. The physician can in this manner survey a large data set without using substantial time for selection and sorting of the data sets to be shown.

Although modifications and changes may be suggested by those skilled in the art, it is the intention of the inventor to embody within the patent warranted hereon all changes and modifications as reasonably and properly come within the scope of his contribution to the art.

1. A method for automatically sorting and representing medical data sets, each data set originating from a medical examination and comprising at least two features, said method comprising the steps of:
automatically electronically ordering all data sets, comprising a predetermined identical value of a first of said features and a non-identical value of a second of said features, in a sequence corresponding to the second feature;
displaying said data sets in said sequence on a display medium.

2. A method as claimed in claim 1 wherein each of said data sets comprises a third feature, and comprising the step of selecting a limited number of data sets for representation on said display medium dependent on said third feature.

3. A method as claimed in claim 2 comprising displaying only data sets having a predetermined identical value of said third feature on said display medium.

4. A method as claimed in claim 2 comprising changing said predetermined identical value of said third feature during display of said data sets on said display medium, and re-sorting and re-displaying said data sets in said sequence after said change.

5. A method as claimed in claim 1 comprising employing data sets respectively originating from a magnetic resonance examination.

6. A method as claimed in claim 5 comprising employing a position of a slice of an examination subject in the magnetic resonance examination as one of said features.

7. A method as claimed in claim 6 comprising employing, for each slice position, at least two data sets generated in temporal succession.

8. A method as claimed in claim 5 comprising employing a dose of a stress agent administered during the magnetic resonance examination as one of said features.

9. A method as claimed in claim 8 comprising employing a position of a slice of an examination subject in whom said stress agent has been administered during said magnetic resonance examination as another of said features, and employing data sets wherein a plurality of slices exist for each dose of said stress agent.

10. A method as claimed in claim 1 wherein each of said data sets comprises a third feature, and comprising the step of selecting a limited number of data sets for representation on said display medium dependent on said third feature, said third feature comprising a point-in-time at which the data set was generated.
